(19) United States
(12) Patent Application Publication
(10) Pub. No.: US 2009/0050545 A1
(43) Pub. Date: Feb. 26, 2009

(54) Lid particularly for a pool return skimmer

(76) Inventor: Joel H. Goffman, Houston, TX (US)

Correspondence Address: LOCKE LORD BISSELL & LIDDELL LLP;ATTN: IP DOCKETING, 600 TRAVIS, SUITE 3400, HOUSTON, TX, 77002-3095, US

(21) Appl. No.: 12/001,824

(22) Filed: Dec. 13, 2007

Related U.S. Application Data
(60) Provisional application No. 60/935,656, filed on Aug. 24, 2007.

(51) Int. Cl. B01D 35/14

(52) U.S. Cl. 210/95

(57) ABSTRACT

A lid for a pool return skimmer is provided, although the lid may be suitable for any environment where dangerous reptiles, insects or the like may be housed. The invention includes a generally circular lid having a top and a bottom and a central region. A rim is provided on the lid for engagement with an opening, such as a pool return skimmer. At least a substantial portion of the lid is made of a substantially clear material, to enable someone about to remove the lid to see whether any undesirable reptiles or any other undesirable or dangerous things are beneath the lid, for example in a pool skimmer.

### CROSS REFERENCE TO RELATED APPLICATIONS

This application is based on and claims priority to Provisional Application 60935656

### STATEMENT REGARDING FEDERALLY SPONSORED RESEARCH OR DEVELOPMENT

NONE

### BACKGROUND OF THE INVENTION

1. Field of the Invention

The inventions disclosed and taught herein relate generally to a lid particularly suited for a pool skimmer or other similar usage where reptiles, insects or the like may pose a danger. More specifically, the invention relates to a pool skimmer lid that is made of a substantially clear material to enable someone to see whether a dangerous reptile or any other undesirable or dangerous things are in the pool skimmer.

2. Description of the Related Art

Prior art lids for pool returns have conventionally been made of a material, typically plastic, that is opaque or that does not otherwise permit someone to see what is in the skimmer. Serious injury can result, for example, if a snake is in the skimmer, because when the lid is removed the person attending to the pool could be struck or bitten by the snake. Other similar dangers are posed by spiders or other insects that may be housed below a lid for a sprinkler system.

The inventions disclosed and taught herein are directed to an improved lid that permits the person about to remove the lid to see what is below, for example in a pool skimmer, before removing the lid and subjecting himself or herself to a dangerous situation.

### BRIEF SUMMARY OF THE INVENTION

The present invention is preferably a lid for a pool return skimmer, although the lid may be suitable for any environment where dangerous reptiles, insects or the like may be housed. The invention comprises a generally circular lid having a top and a bottom and a central region. A rim is provided on the lid for engagement with the opening of a pool return skimmer. At least a substantial portion, for example the central portion, of the lid is made of a substantially clear material, to enable someone about to remove the lid to see whether any undesirable reptiles or any other undesirable or dangerous things are beneath the lid, for example in a pool skimmer.

In a more specific embodiment, a handle may be provided to be cooperable with the lid to facilitate the removal of the lid from the pool return skimmer.

In another more specific embodiment, an opening may be provided in the lid to facilitate the removal of the lid from the pool return skimmer.

In another more specific embodiment, at least substantially the entirety of the lid is made of a substantially clear material.

In another more specific embodiment, the material is plastic.

In another more specific embodiment, the material is polycarbonate.

In another more specific embodiment, the lid includes a central opening, and the handle includes a post which extends through an opening in the lid, a grip on the end of the post above the top of the lid, and a stop associated with the post below the bottom of the lid; with the length of the post being greater than the thickness of the lid.

In another more specific embodiment, the top of the lid includes a recess to receive the grip, so that the top of the grip is substantially flush with the top of the lid.

In another more specific embodiment, the lid includes at least one additional recess to facilitate someone gripping the grip.

In another more specific embodiment, the bottom of the lid includes reinforcement structure, such as ridges.

These and other features and advantages will be become apparent to persons of ordinary skill in the art from the following descriptions.

### BRIEF DESCRIPTION OF THE SEVERAL VIEWS OF THE DRAWINGS

FIG. 1 is a partial perspective view of the top of the lid of one embodiment of the present invention.

FIG. 2 is partial perspective view of the bottom of the lid of one embodiment of the present invention.

FIG. 3 is a side view of the handle that is a more specific aspect of the lid of the present invention.

### DETAILED DESCRIPTION OF THE PREFERRED EMBODIMENT

The Figures described above and the written description of specific structures and functions below are not presented to limit the scope of what the Applicant has invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims.

The present invention is preferably a lid, or cover, for a pool return skimmer, although the lid may be suitable for any environment where dangerous reptiles, insects or the like may be housed. The invention comprises a generally circular lid having a top and a bottom and a central region. A rim is provided on the lid for engagement with an opening, such as an opening associated with a pool return skimmer. At least a substantial portion of the lid is made of a substantially clear material, to enable someone about to remove the lid to see whether any undesirable reptiles or any other undesirable or dangerous things are beneath the lid, for example in a pool skimmer.

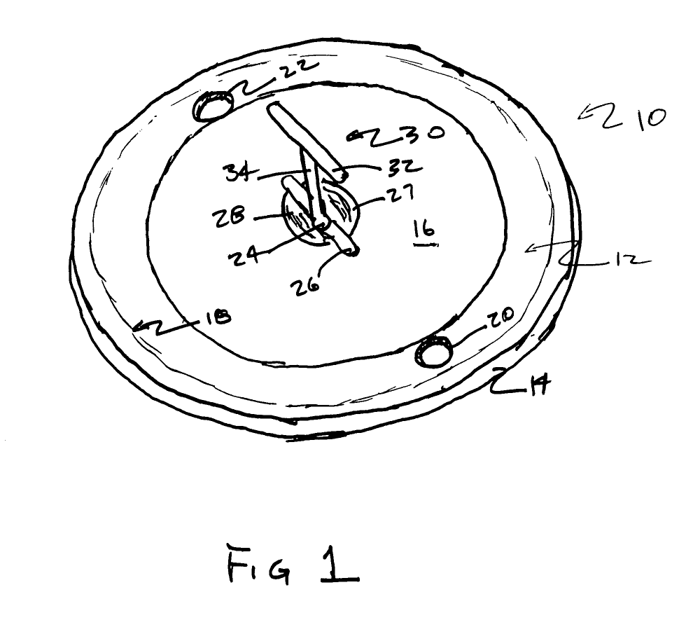

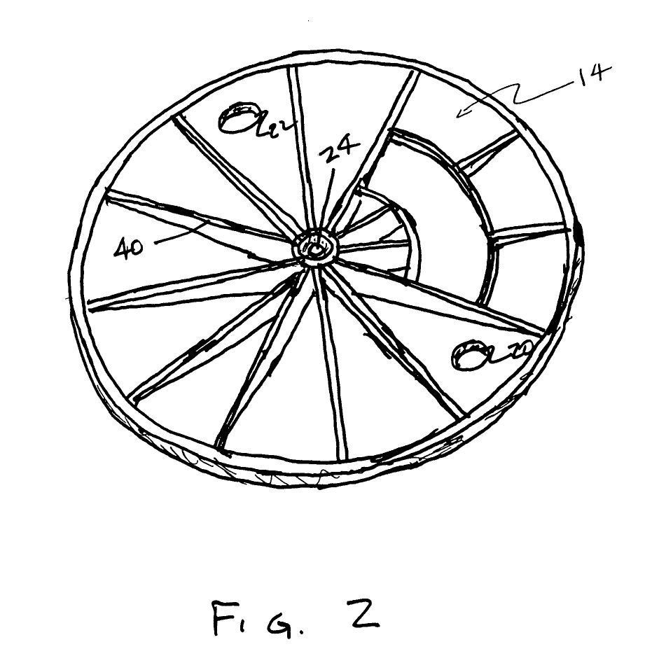

FIG. 1 is an illustration of a preferred embodiment of the present invention. A generally circular lid 10 includes a top 12, as seen in FIG. 1, and a bottom 14, as seen in FIG. 2. The lid also includes a rim 14 for engagement with the opening of a pool return skimmer. The rim 14 may include any desirable optional features, such as enlarged areas, bumps, or other similar features (not shown) to facilitate the lid fitting properly in a pool return opening.

At least a substantial portion of the central region 16 of the lid is made of a substantially clear material, to enable someone about to remove the lid to see whether any undesirable reptiles or any other undesirable or dangerous things are in the pool skimmer or other environment that the lid may be used in. Most preferably, the entire lid is made from one material and is substantially clear.

The top of the lid may optionally include ridges, only one of which 18 is depicted. Such ridges, if used, may provide a decorative touch or reinforcement. Preferably, such ridges will not be included in the central region of the lid, because such ridges may hamper the ability to see what is in the pool skimmer. Alternatively, indentations of any design can be employed.

The lid is preferably made of any suitable plastic material. One suitable material is polycarbonate. Preferably, but optionally, the plastic material will include some blend of materials to inhibit degradation. A particularly suitable plastic is Zylar® 631 from NOVA Chemicals. The lid can be made by any suitable molding technique; one particularly suited technique is injection molding.

The list is depicted as being substantially flat so that it will be flush with decking around the pool, but this is not an essential feature. The lid could be made slightly domed, as well. Also, the lid could be made in a manner to provide some magnification, in order to enhance the ability to see below the lid.

In another more specific, alternative aspect of the preferred embodiment of the lid, one or more openings 20, 22 may be provided in the lid to facilitate the removal of the lid from the pool return skimmer. These openings are depicted as substantially circular, but may be of any desired shape to accommodate someone's fingers or thumbs being inserted into the hole to facilitate the removal of the lid from the pool return opening, or other opening that the lid may be used with, after the person about to remove the lid has been able to check for dangerous reptiles or insects.

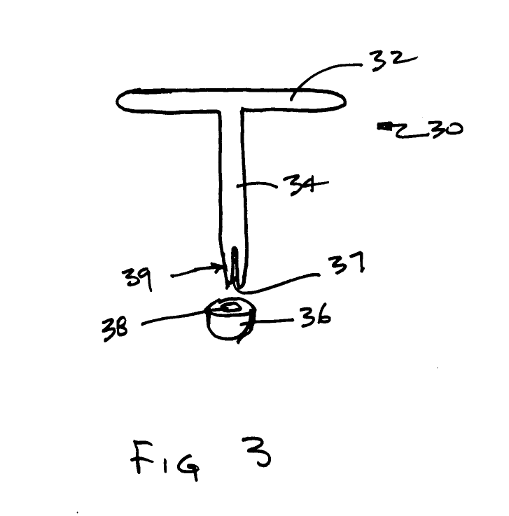

In another more specific, alternative aspect of the preferred embodiment, a handle 30 may be provided to be cooperable with the lid to facilitate the removal of the lid from the pool return skimmer. As best seen in FIGS. 1 and 3, the handle preferably includes a grip 32, a post 34 which extends through an opening 24 in the lid, and a stop 36 associated with the post below the bottom of the lid. The length of the post is greater than the thickness of the lid, to enable the grip to be pulled up away from the top of the lid, as depicted in FIG. 1, to facilitate removal of the lid. As depicted in FIG. 3, the bottom 39 of the post 34 may preferably be tapered to facilitate the insertion of the post into the stop 36. Stop 36 includes an opening 38 to receive the bottom of the post, which may also alternatively include a slotted design to facilitate the portions of the bottom of the post on each side of the slot to be compressed, to even better facilitate the stop bottom fitting in and being retained by the stop 36. When the grip is pulled upward into the position shown in FIG. 1, the stop 36 will engage the bottom of the opening 24 in the lid.

An optional spring (not shown) could be provided around the point below the bottom of the lid, to provide a spring-loaded effect for the handle, if desired.

In another more specific embodiment, the top of the lid includes a recess 26 to receive the grip, so that the top of the grip is substantially flush with the top of the lid. The recess will preferably be substantially complementary in shape to the grip to better achieve the substantially flush fit.

In another more specific embodiment, the lid includes at least one additional recess 27 to facilitate someone gripping the grip. Preferably two recesses 27, 28 are provided and should be sized to enable someone's fingers or thumb to grip the grip 32.

Any other suitable, alternative handle design could be employed, as well.

In another more specific embodiment, the bottom of the lid includes reinforcement structure, such as ridges or webbing 40 of any suitable configuration. The right side of FIG. 2 depicts one design whereas the left side of FIG. 2 depicts another alternative design.

Other and further embodiments utilizing one or more aspects of the inventions described above can be devised without departing from the spirit of Applicant's invention. For example, the present invention has been described in relation to a lid for a pool return. However, the same inventive concept and features could be implemented, for example, for lids for sprinkler systems. Poisonous spiders may be housed below such lids and pose the same type dangerous threat that a snake would pose to someone removing a pool lid. Further, the various embodiments of the present inventive lid can be included in combination with each other to produce variations of the disclosed methods and embodiments. Discussion of singular elements can include plural elements and vice-versa.

The elements have been described functionally and can be embodied as separate components or can be combined into components having multiple functions.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicant, but rather, in conformity with the patent laws, the Applicant intends to fully protect all such modifications and improvements that come within the scope or range of equivalent of the following claims.

What is claimed is:

1. A lid for pool return skimmer or any similar environment where dangerous reptiles, insects or the like may be housed, comprising:
a generally circular lid having a top and a bottom;
a central region of the lid;
a rim on the lid for engagement with an opening, such as the opening of a pool return skimmer;
at least a substantial portion of the lid being made of a substantially clear material, to enable someone about to remove the lid to see whether any undesirable reptiles or any other undesirable or dangerous things are beneath the lid.

2. The lid of claim 1, further comprising:
a handle cooperable with the lid to facilitate the removal of the lid from the pool return skimmer.

3. The lid of claim 1, further including at least one opening to facilitate the removal of the lid from the pool return skimmer.

4. The lid of claims 1, 2, or 3 wherein at least substantially the entirety of the lid is made of a substantially clear material.

5. The lid of claim 4, wherein the material is plastic.

6. The lid of claim 4, wherein the material is polycarbonate.

7. The lid of claim 2, wherein the lid includes a central opening, and wherein the handle includes:
a post which extends through the opening in the lid;
a grip on the end of the post above the top of the lid; and
a stop associated with the post below the bottom of the lid;
the length of the post being greater than the thickness of the lid.

8. The lid of claim 7, wherein the top of the lid includes a recess to receive the grip, so that the top of the grip is substantially flush with the top of the lid.

9. The lid of claim 8, wherein the lid includes at least one additional recess to facilitate someone gripping the grip.

10. The lid of claim 5, wherein the bottom of the lid includes reinforcement structure.
